(19) United States
(12) Patent Application Publication
(10) Pub. No.: US 2002/0056649 A1
(43) Pub. Date: May 16, 2002

(54) Method of fabricating thin magnetic film and electrolytic plating apparatus for fabricating thin magnetic film

(75) Inventor: Mikiko Saito, Tokyo (JP)

Correspondence Address: SUGHRUE, MION, ZINN,, MACPEAK & SEAS, 2100 Pennsylvania Avenue, N.W., Washington, DC, 20037, US

(73) Assignee: NEC CORPORATION

(21) Appl. No.: 09/953,877

(22) Filed: Sep. 18, 2001

(30) Foreign Application Priority Data
Sep. 19, 2000 (JP) 2000-283989

(51) Int. Cl. C25D 3/56; B05C 11/00; B05C 13/00; B05C 13/02

(52) U.S. Cl. 205/255; 118/69

(57) ABSTRACT

A method of fabricating a thin magnetic film composed of Co—Ni—Fe alloy, includes the step of plating an object with plating solution containing Co ions, Ni ions and Fe ions. The plating solution is kept at 20 degrees centigrade or lower while the object is being plated while the object is being plated.

### BACKGROUND OF THE INVENTION

1. Field of the Invention

The invention relates to a method of fabricating a thin magnetic film and an electrolytic plating apparatus for doing the same, and more particularly to a method of fabricating a thin magnetic film having a small coercive force, a small magneto-striction constant, and saturation magnetization in the range of 18000 G to 23000 G both inclusive, and an electrolytic plating apparatus for fabricating such a thin magnetic film.

2. Description of the Related Art

A magnetic head to be mounted on a magnetic disc is required to generate a stronger and stronger and stepper and steeper magnetic field, in order to write data into a magnetic memory medium at a higher density.

For instance, in a magnetic head including a magneto-resistive device for reproducing data and an inductive head device for recording data, it is necessary to compose an upper magnetic layer or both upper and lower magnetic layers in the inductive head device is(are) of magnetic material having a high saturation magnetic density.

The magnetic material is necessary to be readily magnetized by flowing a current through a coil used for writing data into a medium. Hence, the magnetic material has to have a small coercive force and a high magnetic permeability. In other words, the magnetic material has to be soft magnetic material having superior soft magnetic characteristic.

The upper and lower magnetic layers in an inductive head device have been conventionally composed of Ni—Fe alloy, called permaloy, having almost zero magneto-striction constant and containing nickel at about 82%. Such permalloy is called 82-permalloy.

82-permalloy has a saturation magnetic flux density of about 10000 G. A magnetic head could generate a stronger and steeper magnetic field, if composed of magnetic material having a saturation magnetic flux density higher than that of 82-permalloy. As an example, Japanese Patent Publication No, 7-44110 (Japanese Unexamined Patent Publication No. 2-68906) has suggested a magnetic head including a ternary plated film such as a thin magnetic film composed of Co—Ni—Fe, in order to accomplish a high saturation magnetic flux density.

In a thin magnetic film composed of Co—Ni—Fe, since saturation magnetization (Bs) is dependent on a composition ratio of Ni, it is necessary to design a composition ratio of Ni as small as possible for having high saturation magnetization (Bs). On the other hand, it is necessary to set a Ni concentration high in order to have fcc crystal structure having a desired soft magnetic characteristic such as small magneto-striction. Accordingly, it is quite difficult or almost impossible in the thin Co—Ni—Fe magnetic film to satisfy the above-mentioned two requirements contradictory to each other.

Hence, Japanese Patent No. 2821466 has suggested a thin magnetic film composed of Co—Ni—Fe as a ternary plated film of which a magnetic head is composed. The suggested thin magnetic film is designed to have mixed crystal of a γ layer having body-centered cubic structure and a α layer having face-centered cubic structure.

The suggested thin magnetic film has saturation magnetization of 2.0 T or greater and a composition ratio of Ni at about 10 weight %, and does not contain any additives such as saccharin. This structure causes a boundary between fcc and bcc crystal structures to shift towards a side in which a composition ratio of Ni is lower than conventional ones. As a result, the above-mentioned Publication provides a thin soft magnetic film having high saturation magnetization, a small coercive force, and small magneto-striction.

Japanese Unexamined Patent Publications Nos. 7-3489 and 6-346202 have suggested thin soft magnetic films which contain additives such as saccharin to thereby preferentially orient fcc crystal face and define a degree of orientation of fcc(200) to fcc(111), ensuring reduction in a coercive force and a magneto-striction constant.

As mentioned above, the conventional thin magnetic film composed of Co—Ni—Fe could present a small coercive force and a small magneto-striction constant by setting a composition ratio of Ni low, but is accompanied with a problem of unstable crystal structure, resulting in that it would be quite difficult or almost impossible to accomplish stable high saturation magnetization, for instance, saturation magnetization of 18000 to 23000 G.

In order to increase a density in magnetically recording data, it is necessary to present a magnetic head capable of stably providing high recording capacity. In order to accomplish such a magnetic head, it is absolutely necessary to present a magnetic film having high recording capacity and stable characteristics.

The above-mentioned method in which additives such as saccharin is used for preferentially orienting fcc crystal face is accompanied with a problem that high saturation magnetization cannot be stably obtained because of unstable crystal structure of fcc crystal face.

Japanese Unexamined Patent Publication No. 6-89422 has suggested a method of fabricating a magnetic film composed of Co—Fe—Ni. In the suggested method, a ratio of Co ions, Fe ions and Ni ions in plating bath is determined as follows.

Co:Fe:Ni=4-13:1-4:24-42

Japanese Unexamined Patent Publication No. 8-321010 has suggested a thin magnetic film head including a Co—Ni—Fe film having a composition ratio as follows, and having an average crystal diameter in the range of 12 nm to 20 nm both inclusive.

Co: 60-75 weight %

Ni: 17-25 weight %

Fe: 3-9 weight %

The above-mentioned problems remain unsolved even in these Publications.

### SUMMARY OF THE INVENTION

In view of the above-mentioned problems in the conventional magnetic films, it is an object of the present invention to provide (a) a method of fabricating a thin magnetic film having small coercive force and small magneto-striction constant, and stably providing high saturation magnetization, for instance, saturation magnetization of 18000 G to 23000 G, and (b) an electrolytic plating apparatus for doing the same.

The inventor conducted a lot of experiments, and found the facts as follows.

In Co—Ni—Fe magnetic materials, saturation magnetization, coercive force and a magneto-striction constant can be controlled in accordance with not only a composition thereof, but also crystal structure thereof.

For instance, by designing crystal structure such that fcc crystal face is preferentially oriented, it is possible to fabricate a thin magnetic film having small coercive force and small magneto-striction constant, and further having high saturation magnetization, without using additives such as saccharin. In other words, it is possible to obtain a thin magnetic film having small coercive force and small magneto-striction constant, by having the thin magnetic film had a low composition ratio of Ni.

In addition, the inventor had found out that when a thin magnetic film was to be fabricated by means of electrolytic plating, crystal structure in the thin magnetic film was dependent on conditions for carrying out electrolytic plating. Hence, it is now understood that a thin magnetic film having high saturation magnetization can be fabricated by suitably determining conditions for carrying out electrolytic plating.

The present invention was made based on the above-mentioned facts.

Specifically, in one aspect of the present invention, there is provided a method of fabricating a thin magnetic film composed of Co—Ni—Fe alloy, including the step of plating an object with plating solution containing Co ions, Ni ions and Fe ions, the plating solution being kept at 20 degrees centigrade or lower while the object is being plated.

It is preferable that the object is plated at a current density of 15 mA/cm² or greater.

The method may further include the step of annealing the plated object at a temperature in the range of 100 to 250 degrees centigrade both inclusive.

It is preferable that the plating solution contains Co ions at 0.05 to 0.4 mol/liter both inclusive, Ni ions at 0.03 to 0.2 mol/liter both inclusive, and Fe ions at 0.005 to 0.05 mol/liter both inclusive.

In another aspect, there is provided an electrolytic plating apparatus for fabricating a thin magnetic film composed of Co—Ni—Fe alloy, including a plating bath containing plating solution containing Co ions, Ni ions and Fe ions, and a conditioner which keeps the plating solution at 20 degrees centigrade or lower while plating is being carried out.

The apparatus may further include a controller which keeps a plating current at 15 mA/cm² or greater.

There is further provided an electrolytic plating apparatus or fabricating a thin magnetic film composed of Co—Ni—Fe alloy, including a plating bath containing plating solution containing Co ions, Ni ions and Fe ions, a heat exchanger which keeps cooling medium at a predetermined temperature, a reservoir temporarily pooling the plating solution and feeding the plating solution to the heat exchanger, a tube arranged along an inner surface of the plating bath and connected at one end to the heat exchanger and at the other end to the reservoir, and a pump for feeding the cooling medium in a loop path defined by the heat exchanger, the tube, the plating bath and the reservoir, the cooling medium being cooled by the heat exchanger and being fed through the tube in the plating bath to thereby keep the plating solution at 20 degrees centigrade or lower.

For instance, the tube is preferably composed of teflon.

The advantages obtained by the aforementioned present invention will be described hereinbelow.

In accordance with the present invention, it is possible to provide a thin magnetic film having high saturation magnetization, for instance, in the range of 18000 G to 23000 G both inclusive. Thus, a thin magnetic film having high saturation magnetization and stable characteristics can be obtained.

The above and other objects and advantageous features of the present invention will be made apparent from the following description made with reference to the accompanying drawings, in which like reference characters designate the same or similar parts throughout the drawings.

### BRIEF DESCRIPTION OF THE DRAWINGS

FIG. 1 is a schematic view of an electrolytic plating apparatus in accordance with the first embodiment of the present invention.

FIG. 2 is a chart of X-ray diffraction indicative of crystal structure of the thin magnetic film fabricated by the apparatus illustrated in FIG. 1.

FIG. 3 is a graph showing a relation between crystal structure and saturation magnetization in the thin magnetic film fabricated by the apparatus illustrated in FIG. 1.

FIG. 4 is a graph showing a relation between a film-fabrication rate and a temperature of Co—Ni—Fe plating solution in the apparatus illustrated in FIG. 1.

FIG. 5 is a cross-sectional view of a magnetic head including the thin magnetic film fabricated by the apparatus illustrated in FIG. 1.

FIG. 6 is a partial cross-sectional view of a magnetic head including the thin magnetic film fabricated by the apparatus illustrated in FIG. 1.

### DESCRIPTION OF THE PREFERRED EMBODIMENTS

[First Embodiment]

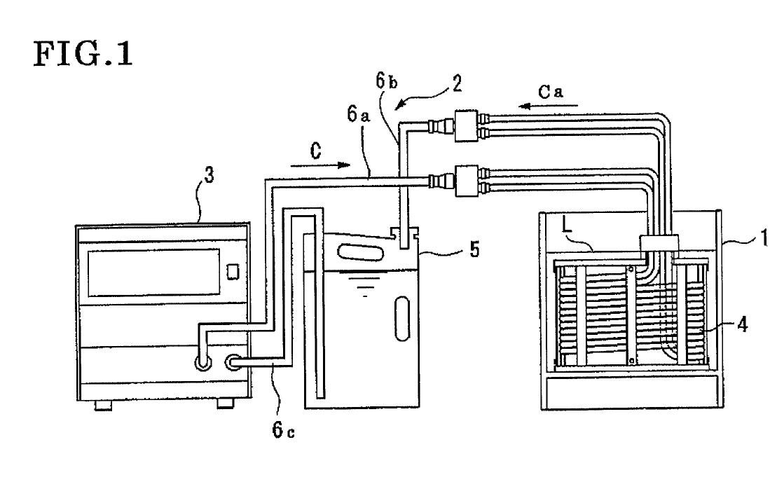

FIG. 1 illustrates an electrolytic plating apparatus in accordance with the first embodiment of the present invention for fabricating a magnetic head including a thin magnetic film composed of Co—Ni—Fe alloy.

The illustrated electrolytic plating apparatus is comprised of a plating bath 1 containing plating solution L containing Co ions, Ni ions and Fe ions, and a cooler 2 for cooling the plating solution and keeping the plating solution at a temperature at 20 degrees centigrade or lower.

The cooler 2 is comprised of a heat exchanger 3 which keeps cooling medium C at a predetermined temperature, for instance, 20 degrees centigrade, a reservoir 5 temporarily pooling the plating solution Ca fed back from the plating bath 1, and feeding the plating solution Ca to the heat exchanger 3, a teflon tube 4 arranged in a spiral along an inner surface of the plating bath 1, a first conduit 6a fluid-communicating the teflon tube 4 and the heat exchanger 3 to each other, a second conduit 6b fluid-communicating the teflon tube 4 and the reservoir 5 to each other, a third conduit 6c fluid-communicating the reservoir 5 and the heat exchanger 3 to each other, and a pump (not illustrated) for feeding the cooling medium C in a loop path defined by the heat exchanger 3, the first conduit 6a, the teflon tube 4, the second conduit 6b, the reservoir 5, and the third conduit 6c.

The cooling medium C is comprised of antifreeze solution and water.

The cooling medium is cooled by the heat exchanger 3 and fed through the spiral-shaped teflon tube 4 in the plating bath 1 to thereby keep the plating solution L at 20 degrees centigrade or lower.

The plating solution L is circulated in the plating bath 1 by means of a pump (not illustrated) to keep the plating solution L in an entirety at a predetermined temperature.

In addition, paddle plating process is carried out so as to keep providing fresh plating solution L to a surface on which a plated film is to be formed, and keep pH constant at the surface. A rate at which the plating solution is circulated in the plating bath 1 is determined such that temperatures of the plating solution L and the plating bath 1 are kept constant.

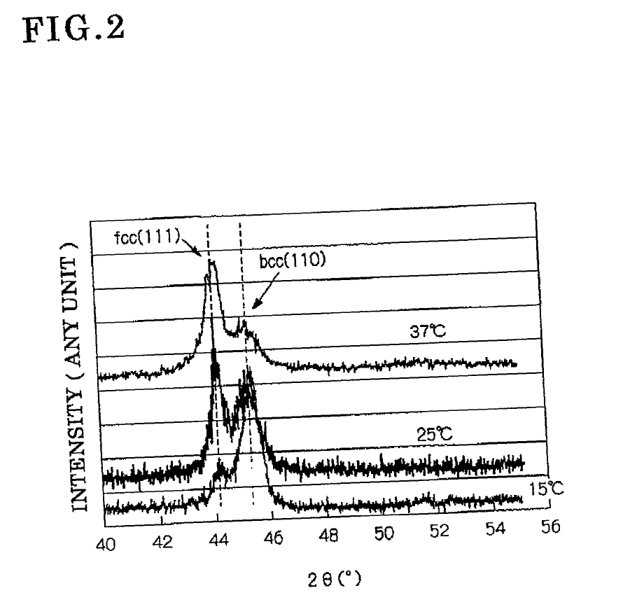

FIG. 2 is a X-ray diffraction chart indicating the results of observing crystal structure of a thin magnetic film fabricated by the electrolytic plating apparatus illustrated in FIG. 1.

In observing the crystal structure, the plating solution L was kept at 20 degrees centigrade or lower, and the plating solution L was designed to have the following composition:

| | |
|---|---|
| CoSO₄ | 0.092 mol/liter; |
| NiSO₄ | 0.20 mol/liter; |
| NH₄Cl | 0.28 mol/liter; |
| H₃BO₃ | 0.40 mol/liter; |
| FeSO₄ | 0.016 mol/liter; and |
| Sodium laurie acid | 0.00035 mol/liter. |

The conditions for plating were determined as follows.

| Current density | 15.0 mA/cm² |
|---|---|
| pH | 2.7 |

Herein, the apparatus may be designed to include a current controller (not illustrated) for keeping a plating current at a current density of 15 mA/cm² or greater.

As is obvious in view of FIG. 2, bcc orientation becomes predominant, as a temperature of the plating solution L reduces.

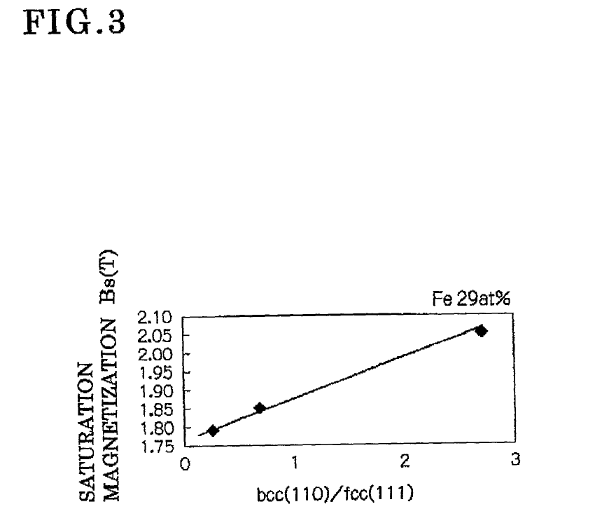

FIG. 3 shows the results of observation about saturation magnetization of the thin magnetic film fabricated by the apparatus illustrated in FIG. 1. In FIG. 3, a relation between bcc(110)/fcc(111) and saturation magnetization (Bs) is shown.

It was found out in view of FIG. 3 that the saturation magnetization (Bs) became greater, as the bcc orientation becomes greater. Hence, it is understood that one of conditions for enhancing the bcc orientation of the thin magnetic film is reduction in a temperature of the plating solution L.

In general, a plating solution is kept equal to or higher than a room temperature in a plating process in order to enhance uniformity of a composition of the plating solution and increase a plating rate.

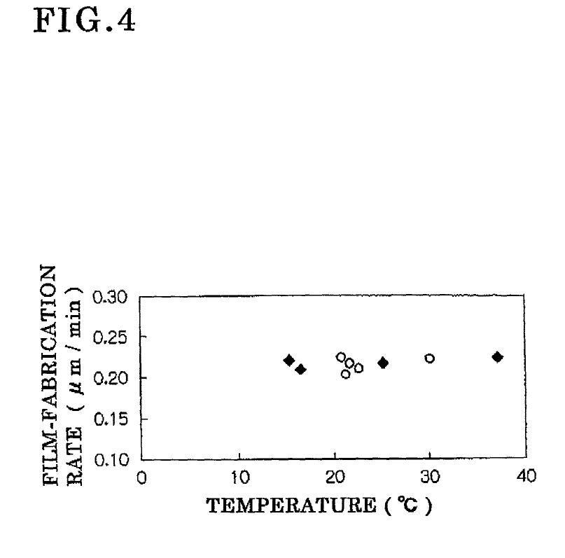

FIG. 4 shows the result of observation about a relation between a temperature of Co—Ni—Fe plating solution and a film-fabrication rate.

It was found out that a constant film-fabrication rate could be ensured in a range of the tested temperature, that is, in the range of about 15 to about 40 degrees centigrade.

In addition, it was confirmed that the thin magnetic film had uniform composition in a plane of a usually used, 2-inch or larger sized substrate. Furthermore, it was confirmed that only crystal structure was varied when a temperature varied.

The inventor had conducted the experiments to find a suitable range of an intensity of diffracted X-ray.

The results of the experiments show that a ratio fcc (200)/fcc (111) is preferably equal to 0.25 or smaller, and a ratio X1/X2 is preferably in the range of 0.01 to 3.0 both inclusive, wherein fcc (200) indicates an intensity of diffracted X-ray at (200) face of a face-centered cubic lattice in a thin magnetic film composed of Co—Ni—Fe alloy, fcc (111) indicates an intensity of diffracted X-ray at (111) face of a face-centered cubic lattice in a thin magnetic film composed of Co—Ni—Fe alloy, X1 indicates a peak intensity ratio of an intensity bcc (110) of diffracted X-ray at (110) face of a body-centered cubic lattice in a thin magnetic film composed of Co—Ni—Fe alloy, and X2 indicates a peak intensity ratio of an intensity fcc (111) of diffracted X-ray at (111) face of a face-centered cubic lattice in a thin magnetic film composed of Co—Ni—Fe alloy.

In addition, it was also found out that a preferable composition of the above-mentioned Co—Ni—Fe alloy was as follows:

Co: 40-70 weight %;

Ni: 2-20 weight %; and

Fe: 15-40 weight %.

[Second Embodiment]

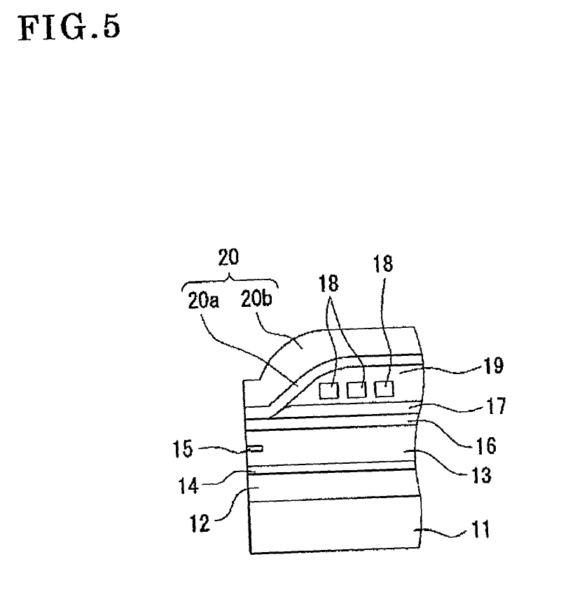

FIG. 5 is a cross-sectional view of a magnetic head including the thin magnetic film fabricated by the apparatus illustrated in FIG. 1. Specifically, an underlying film is formed on an electrically insulating layer by sputtering, and the thin magnetic film composed of Co—Ni—Fe alloy is formed on the underlying film by electrolytic plating.

With reference to FIG. 5, the magnetic head is comprised of a substrate 11 as a slider composed of complex ceramics of aluminum oxide (Al₂O₃) and titanium carbide (TiC), a MR head having a function of re-producing data, formed on the substrate 11, and an ID head formed on the MR head.

The MR head is comprised of a lower shield 12 formed on the substrate 11 and comprised of a patterned CoZrTa film, an upper shield comprised of a NiFe film containing Ni at about 80 weight %, a magnetic separator 14 composed of alumina or aluminum oxide (Al₂O₃) and sandwiched between the lower shield 12 and the upper shield 13, and a magneto-resistance effect device 15 formed in the upper shield 13.

The lower shield 12 has a thickness of 1 μm, and the upper shield has a thickness of 3 μm. A gap between the lower and upper shields 12 and 13, that is, a thickness of the magnetic separator 14 is set equal to 0.13 μm.

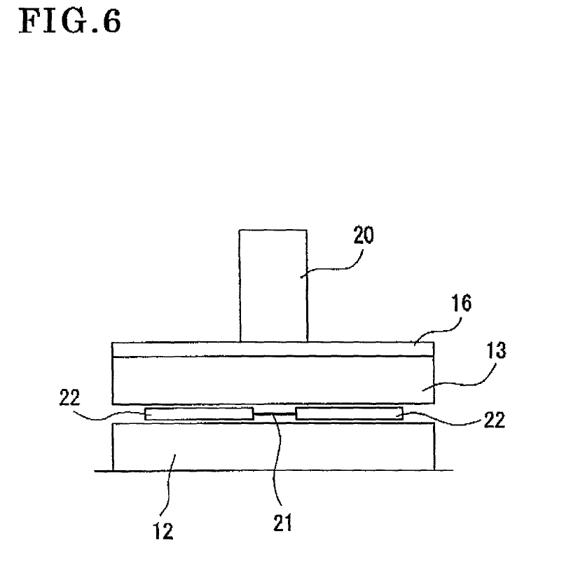

FIG. 6 illustrates a structure of the magneto-resistance effect device 15. As illustrated in FIG. 6, the magneto-resistance effect device 15 is comprised of a central region 21 sensitizing a magnetic field radiated from a recording medium, and end regions 22 sandwiching the central region 21 therebetween. The end regions 22 provide a bias field and a current to the central region 21.

The central region 21 has a multi-layered structure having GMR effect which generally called spin-valve effect. Specifically, the central region 21 is comprised of a multi-layered structure in which an underlying Zr film having a thickness of 3 nm, a PtMn film having a thickness of 20 nm, a CoFe film having a thickness of 2 nm, a Cu film having a thickness of 2.1 nm, a CoFe film having a thickness of 0.5 nm, a NiFe film having a thickness of 2 nm, and a Zr film having a thickness of 3 nm are layered one on another in this order viewed from the lower shield 12.

The central region 21 has a width of 0.5 μm which defines a width of reproducing track. Each of the end regions 22 has a multi-layered structure including a CoPt film acting as a permanent magnet film and having a thickness of 20 nm, and an Au film acting as an electrode film and having a thickness of 50 nm.

As mentioned above, an ID head is formed on the MR head. The ID head has a function of recording data, using the upper shield 13 as a lower magnetic pole.

The ID head is comprised of a magnetic gap 16 formed on the upper shield 13, a first non-magnetic insulator 17 formed on the magnetic gap 16, a second non-magnetic insulator 19 formed on the first non-magnetic insulator 17, a plurality of coils 18 formed in the second non-magnetic insulator 19, and an upper magnetic pole 20 formed covering the magnetic gap 16, the first non-magnetic insulator 17 and the second non-magnetic insulator 19 therewith.

The upper shield 13 is composed of 82-permalloy, and the thin Co—Ni—Fe magnetic film formed on 82-permalloy and fabricated by the apparatus illustrated in FIG. 1.

The magnetic gap 16 formed on the upper shield 13 is composed of alumina or aluminum oxide (Al₂O₃) and has a thickness of 0.18 μm.

The first non-magnetic insulator 17 formed above the upper shield 13 with the magnetic gap 16 being sandwiched therebetween defines a zero throat height. The first non-magnetic insulator 17 is composed of photoresist.

Each of the coils 18 is comprised of a copper-plated film, and is electrically insulated from surroundings by the second non-magnetic insulator 19. The second non-magnetic insulator 19 is composed of photoresist.

The upper magnetic pole 20 covers the second non-magnetic insulator 19 therewith, and is exposed to ABS facing a recording medium.

The upper magnetic pole 20 is comprised of a 82-permalloy film 20a formed by sputtering as an underlying layer, and a magnetic pole 20b formed on the 82-permalloy film 20a. The magnetic pole 20b is composed of the thin Co—Ni—Fe magnetic film fabricated through the apparatus illustrated in FIG. 1 and having saturation magnetization (Bs) of 2T. The upper magnetic pole has a thickness of 1.0 μm.

Hereinbelow is explained a method of fabricating the upper shield 13 acting as a lower magnetic pole, and the upper magnetic pole 20.

The upper shield 13 and the upper magnetic pole 20 were fabricated by means of the apparatus illustrated in FIG. 1. The plating solution was designed to have the following composition:

| | |
|---|---|
| CoSO₄ | 0.092 mol/liter; |
| NiSO₄ | 0.20 mol/liter; |
| NH₄Cl | 0.28 mol/liter; |
| H₃BO₃ | 0.40 mol/liter; |
| FeSO₄ | 0.016 mol/liter; and |
| Sodium laurie acid | 0.00035 mol/liter. |

The plating solution was pooled in the plating bath 1, stirred for 15 hours or longer, and then, cooled down to 15 degrees centigrade by means of the cooler 2. Thereafter, the plating solution was circuited in the plating bath. Then, a Co—Ni—Fe film was formed on a substrate by paddle process. The thus formed Co—Ni—Fe film had a composition as follows:

Co: 65 weight %;

Ni: 12 weight %: and

Fe: 23 weight %.

The Co—Ni—Fe film had a specific resistance ρ of 20 μΩcm.

There could be fabricated a magnetic memory device having a recording density of about 10 gigabit/square inch or greater, by using the above-mentioned complex magnetic head, having the recording medium had a coercive force of 3500 Oe or greater, and setting magnetic gap between the recording medium and the magnetic head, equal to 35 nm.

[Third Embodiment]

In the third embodiment, a reproducing section and a recording section of a magnetic head are fabricated. The upper shield 13 and the upper magnetic pole 20 in the magnetic head were fabricated through the apparatus illustrated in FIG. 1.

The plating solution was designed to have the following composition.

| | |
|---|---|
| CoSO₄ | 0.092 mol/liter; |
| NiSO₄ | 0.20 mol/liter; |
| NH₄Cl | 0.28 mol/liter; |
| H₃BO₃ | 0.40 mol/liter; |
| FeSO₄ | 0.016 mol/liter; and |
| Sodium laurie acid | 0.00035 mol/liter. |

The conditions for plating were determined as follows.

| Current density | 20.0 mA/cm² |
|---|---|
| pH | 2.7 |

The plating solution having the above-mentioned composition was pooled in the plating bath 1, stirred for 15 hours or longer, and then, circuited in the plating bath. Then, a Co—Ni—Fe film was formed on a substrate by paddle process at a room temperature and at a current density of 20.0 mA/cm². Thereafter, the film was annealed at a temperature in the range of 100 to 250 degrees centigrade. As a result, there was formed the thin Co—Ni—Fe magnetic film.

The thus formed Co—Ni—Fe magnetic film had a composition as follows:

Co: 65 weight %;

Ni: 12 weight %; and

Fe: 23 weight %.

The Co—Ni—Fe film had a specific resistance ρ of 20 μΩcm.

By using the magnetic head in accordance with the third embodiment, it was possible to have the recording medium had a coercive force of 3500 Oe or greater, and set the magnetic gap between the recording medium and the magnetic head, equal to 35 nm. As a result, a magnetic memory device having a recording density of about 10 gigabit/square inch or greater was obtained.

While the present invention has been described in connection with certain preferred embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

The entire disclosure of Japanese Patent Application No. 2000-283989 filed on Sep. 19, 2000 including specification, claims, drawings and summary is incorporated herein by reference in its entirety.

What is claimed is:

1. A method of fabricating a thin magnetic film composed of Co—Ni—Fe alloy, comprising the step of plating an object with plating solution containing Co ions, Ni ions and Fe ions, said plating solution being kept at 20 degrees centigrade or lower while said object is being plated.

2. The method as set forth in claim 1, wherein said object is plated at a current density of 15 mA/cm² or greater.

3. The method as set forth in claim 1, further comprising the step of annealing the plated object at a temperature in the range of 100 to 250 degrees centigrade both inclusive.

4. The method as set forth in claim 1, wherein said plating solution contains Co ions at 0.05 to 0.4 mol/liter both inclusive, Ni ions at 0.03 to 0.2 mol/liter both inclusive, and Fe ions at 0.005 to 0.05 mol/liter both inclusive.

5. An electrolytic plating apparatus for fabricating a thin magnetic film composed of Co—Ni—Fe alloy, comprising
a plating bath containing plating solution containing Co ions, Ni ions and Fe ions; and
a conditioner which keeps said plating solution at 20 degrees centigrade or lower while plating is being carried out.

6. The apparatus as set forth in claim 5, further comprising a controller which keeps a plating current at 15 mA/cm² or greater.

7. An electrolytic plating apparatus for fabricating a thin magnetic film composed of Co—Ni—Fe alloy, comprising:
a plating bath containing plating solution containing Co ions, Ni ions and Fe ions;
a heat exchanger which keeps cooling medium at a predetermined temperature;
a reservoir temporarily pooling said plating solution and feeding said plating solution to said heat exchanger;
a tube arranged along an inner surface of said plating bath and connected at one end to said heat exchanger and at the other end to said reservoir; and
a pump for feeding said cooling medium in a loop path defined by said heat exchanger, said tube, said plating bath and said reservoir,
said cooling medium being cooled by said heat exchanger and being fed through said tube in said plating bath to thereby keep said plating solution at 20 degrees centigrade or lower.

8. The electrolytic plating apparatus as set forth in claim 7, wherein said tube is composed of teflon.

9. The apparatus as set forth in claim 7, further comprising a controller which keeps a plating current at 15 mA/cm² or greater.
